(19) United States
(12) Patent Application Publication
(10) Pub. No.: US 2007/0297710 A1
(43) Pub. Date: Dec. 27, 2007

(54) Electro-optical apparatus, method of manufacturing electro-optical apparatus, and electronic equipment

(75) Inventor: Tomio Suzuki, Fujimi-cho (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 11/809,938

(22) Filed: Jun. 4, 2007

(30) Foreign Application Priority Data
Jun. 12, 2006 (JP) 2006-161988

(51) Int. Cl. G02F 1/295

(52) U.S. Cl. 385/8

(57) ABSTRACT

An electro-optical apparatus includes: a first substrate; a plurality of pixels each having an aperture on one surface of the first substrate; a microlens substrate arranged on the side of the other side of the first substrate opposing the one surface and having lens surfaces of microlenses in the respective apertures on the surface thereof; and an adhesive layer filled in the lens surfaces for bonding the microlens substrate and the first substrate to each other.

### BACKGROUND

1. Technical Field

The present invention relates to a technical field of an electro-optical apparatus such as a liquid crystal panel provided with microlenses, a method of manufacturing the same, and electronic equipment such as a liquid crystal projector provided with such the electro-optical apparatus.

2. Related Art

In the electro-optical apparatus of this type, an apparatus body includes a TFT array substrate in which electronic elements such as TFTs (Thin Film Transistors) as pixel switching elements are integrated, an opposed substrate arranged so as to oppose the TFT array substrate, and a layer of electro-optical substance such as a liquid crystal layer provided between these substrates. Arranged on both surfaces of the apparatus body are dustproof glasses to restrain lowering of image quality due to attachment of dust on apertures of pixels.

On the other hand, in the electro-optical apparatus of this type, for example, microlenses corresponding to the respective pixels are integrated or a microlens array panel in which a plurality of the microlenses are integrated is bonded to the opposed substrate. With such microlenses, light beams which are supposed to travel toward non-opening areas other than the apertures of the respective pixels are converged in the respective areas, so that these light beams are guided to the apertures of the respective pixels when being transmitted through the layer of the electro-optical substance. Consequently, a bright display of the electro-optical apparatus is achieved. An example of a liquid crystal display device provided with the microlenses is disclosed in JP-A-3-170911.

However, in the electro-optical apparatus having the configuration as described above, the electro-optical apparatus is manufactured through a complicated process including a step of bonding the dustproof glasses to the TFT array substrate and the opposed substrate respectively in addition to a step of bonding the opposed substrate to the TFT array substrate, so that there arises a problem that the electric power to be consumed in the process of manufacturing the electro-optical apparatus is increased. In particular, in a process of a large-scale production for manufacturing the liquid crystal panels, it is preferable to restrain increase in power consumption, that is, increase in energy consumption as much as possible for reducing the load to be applied to the environment. In addition, effective utilization of resources is also expected by reducing the number of members which constitute the electro-optical apparatus.

### SUMMARY

An advantage of some aspects of the invention is that an electro-optical apparatus which is capable of reducing the load to be applied to the environment and effectively utilizing resources, a method of manufacturing such the electro-optical apparatus, and electronic equipment are provided.

In order to solve the above-described problem, an electro-optical apparatus according to an embodiment of the invention includes: a first substrate; a plurality of pixels on one surface of the first substrate, each pixels having an aperture; a microlens substrate arranged on an other side of the first substrate opposite from the one surface and having lens surfaces of microlenses located at the respective apertures on the surface thereof; and an adhesive layer filled in the lens surfaces for bonding the microlens substrate and the first substrate to each other.

In the electro-optical apparatus according to the embodiment of the invention, a liquid crystal layer is provided between the first substrate such as a TFT array substrate and a second substrate such as an opposed substrate arranged so as to oppose the first substrate. Apertures of the plurality of pixels which constitute the pixel areas on the second substrate are defined by a light-shielding film or wirings provided on the first substrate. The term “apertures” represents the areas in the pixels through which light beams practically pass through, for example, the areas where the light beams converged into the pixels by the microlenses, described later, are not blocked by the wirings, the light-shielding film, electronic elements, and so on. In contrast, the area where the wirings, the light-shielding film, and so on are formed in the pixels, and hence the light beams which contribute to display do not pass through, that is, the areas which partition the apertures from each other are referred to as “non-opening areas”.

The microlens substrate is arranged on the side of the other surface of the first substrate opposing the one surface, and is formed with the lens surfaces of the microlenses in the respective apertures on the surface thereof. The microlens substrate of this type is bonded to the first substrate via, for example, a transparent adhesive layer. By the adhesive layer being filled, the lens surfaces are formed with the microlenses to converge incident light beams entering from the side of the back surface of the microlens substrate, that is, from the side opposite from the first substrate with reference to the microlens substrate into the apertures. According to the microlenses as described above, the light beams are converged effectively in the aperture, so that the light amount to be supplied to the aperture is increased and the luminance of the pixels is enhanced.

According to the electro-optical apparatus according to the embodiment of the invention, since the microlens substrate is bonded to the other surface of the TFT array substrate via the adhesive layer, the number of substrates may be reduced in comparison with the case of forming a microlens substrate formed by bonding a cove glass to a transparent member in a state in which the transparent member is filled in the lens surfaces is formed separately, bonding the formed microlens substrate to the TFT array substrate and bonding a dustproof glass to these substrates. More specifically, according to the electro-optical apparatus in the embodiment of the invention, two substrates may be eliminated from five substrates including the two dustproof glasses, the TFT array substrate, the opposed substrate, and the microlens substrate. Therefore, the number of members which constitute the electro-optical apparatus may be reduced, and hence resources may be effectively utilized. In addition, since the step of bonding the dustproof glasses to the TFT array substrate and the opposed substrate performed in the related art may be eliminated, a heat curing step or a UV curing step for curing the adhesive agent for bonding these substrates may be eliminated. Therefore, the power consumption during the heat curing step or the UV curing step may be reduced, and hence the load applied to the environment, which increases with increase of the energy consumption, may be reduced.

According to the electro-optical apparatus according to the embodiment of the invention, since the light beams are converged into the apertures from the side of the other surface of the first substrate such as the TFT array substrate, it is not necessary to provide the light-shielding film on the second substrate in order to block the light beams entering through the one surface when viewed from the first substrate. More specifically, since the electronic elements may be blocked from the light beams by the wirings or the like having the light-shielding property, which are formed in advance on the side of the one surface of the first substrate and the light beams entering from the opposite side from the one surface on which the electronic elements are formed when viewed from the first substrate is converged by the microlens substrate, the light beams to be guided to the non-opening areas may be reduced. Therefore, a step of forming the light-shielding film on the second substrate may be reduced and hence cost reduction required for manufacturing the electro-optical apparatus and reduction of the energy consumption may be enabled. The electronic elements such as the TFTs must simply be formed on one of the surfaces of the first substrate, and they may be formed on the surface of the second substrate which is exposed to the first substrate.

As described above, according to the electro-optical apparatus according to the embodiment of the invention, since reduction of the energy consumed in the manufacturing process and effective utilization of the resources are enabled, an electro-optical apparatus in which the load applied to the environment is reduced is provided.

Preferably, there is provided a second substrate which is arranged on the side of the one surface of the first substrate so as to oppose thereto via an electro-optical substance, and the thickness of the first substrate may be thinner than the respective thicknesses of the microlens substrate and the second substrate.

In this configuration, the incident light beams may be efficiently converged into the apertures according to the thicknesses of the microlens substrate and the second substrate. The thickness of the first substrate is set independently in detail according to the value of the pixel pitch, the relative relation between the thicknesses of the second substrate and the microlens substrate, the refractive indexes of the respective substrates and the adhesive layers.

In order to solve the above described problem, there is provided a method of manufacturing an electro-optical apparatus according to the embodiment of the invention, including a first substrate; a plurality of pixels on one surface of the first substrate, each pixels having an aperture; a microlens substrate arranged on an other side of the first substrate opposite from the one surface and having lens surfaces of microlenses located at the respective apertures on the surface thereof; and an adhesive layer filled in the lens surfaces for bonding the microlens substrate and the first substrate to each other, including: forming the adhesive layer; and bonding the microlens substrate and the first substrate via the adhesive layer.

In this configuration, since reduction of the energy consumed in the manufacturing process and effective utilization of the resources are enabled as the electro-optical apparatus described above, an electro-optical apparatus in which the load applied to the environment is reduced is provided.

In order to solve the above-described problem, electronic equipment according to the embodiment of the invention includes the electro-optical apparatus according to the embodiment of the invention described above.

In this configuration, since the electro-optical apparatus according to the embodiment of the invention as described above is provided, various types of electronic equipment such as projective display devices, mobile phones, electronic data books, word processors, view-finder type or monitor-direct-view video tape recorders, work stations, TV phones, POS terminals, touch panels, and so on which achieves high-quality display are realized. It is also possible to realize an electrophoresis apparatus such as electronic paper as the electronic equipment according to the embodiment of the invention.

The effect described above and other advantages of the invention will be apparent by the description given below.

### BRIEF DESCRIPTION OF THE DRAWINGS

The invention will be described with reference to the accompanying drawings, wherein like numbers reference like elements.

FIG. 1A is a schematic perspective view of a microlens substrate.

FIG. 1B is a schematic perspective view showing a configuration of a cross-section taken along the line IB-IB in FIG. 1A.

FIG. 2 is an enlarged plan view of the microlens substrate to be applied to an electro-optical apparatus according to an embodiment.

FIG. 3 is a plan view of the electro-optical apparatus according to the embodiment.

FIG. 4 is a cross-sectional view taken along the line IV-IV in FIG. 3.

FIG. 5 is a cross-sectional view showing a configuration of a comparative example of a liquid crystal device according to the embodiment.

FIG. 6 is a circuit diagram showing an equivalent circuit including various elements and wirings in a plurality of pixels formed in a matrix pattern, which constitutes an image display area of the electro-optical apparatus according to the embodiment.

FIG. 7 is a cross-sectional view corresponding to

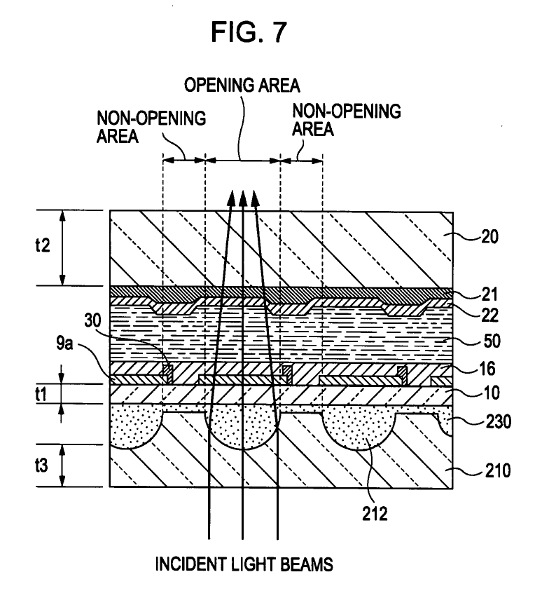

FIG. 4 showing a principal portion of the cross-section of the pixel portion of the liquid crystal device 1 taken along the line in an enlarged scale.

FIGS. 8A to 8D are process cross-sectional views schematically showing a method of manufacturing the electro-optical apparatus according to the embodiment.

FIGS. 9A and 9B are process cross-sectional views schematically showing a method of manufacturing the electro-optical apparatus according to the embodiment.

FIG. 10 is a schematic cross-sectional view showing a projective color display device as an example of electronic equipment according to the embodiment.

### DESCRIPTION OF EXEMPLARY EMBODIMENTS

Referring now to the drawings, embodiments of an electro-optical apparatus, a method of manufacturing the electro-optical apparatus, and electronic equipment will be described, respectively.

### 1: Microlens Substrate

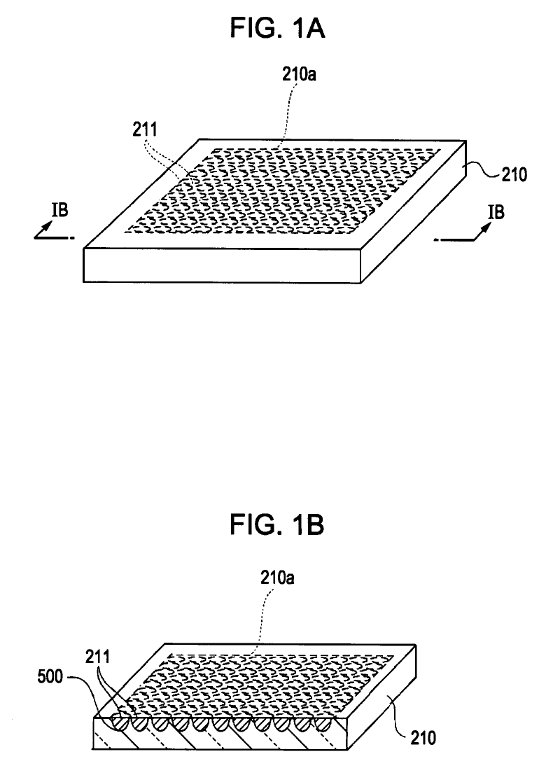

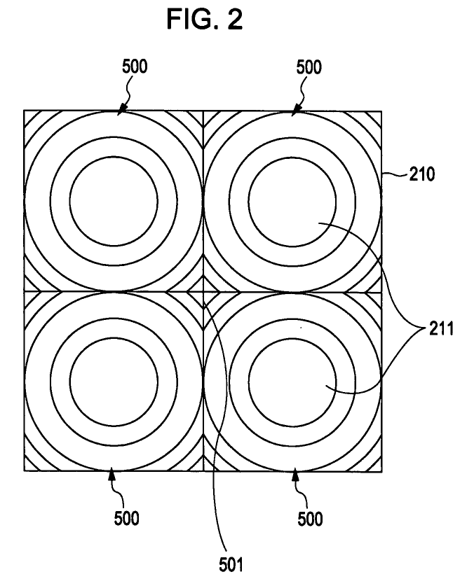

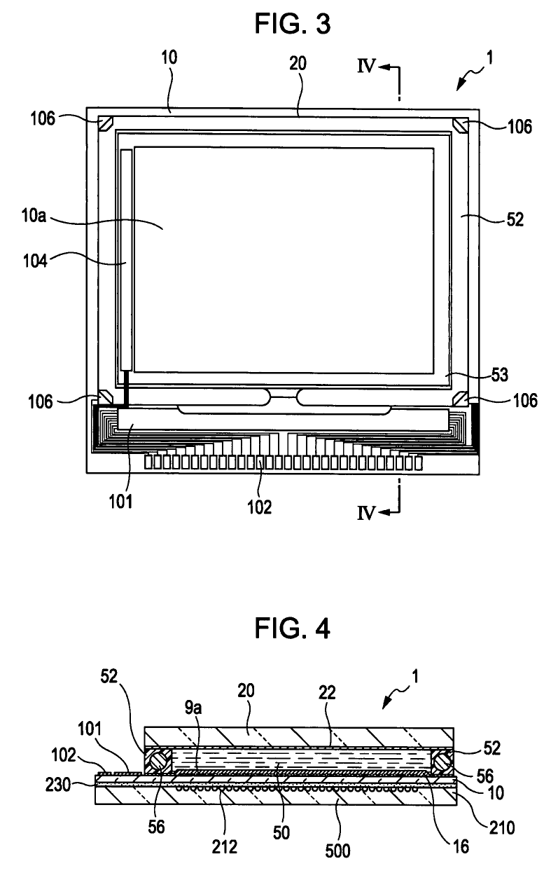

Referring now to FIG. 1 and FIG. 2, a configuration of a microlens substrate applied to an electro-optical apparatus according to an embodiment.

FIG. 1A is a schematic perspective view of a microlens substrate 210 and FIG. 1B is a schematic perspective view showing a configuration of a cross section taken along the line IB-IB in FIG. 1A. FIG. 2 is an enlarged plan view showing recesses 211.

In FIG. 1A, the microlens substrate 210 is, for example, a transparent substrate such as a quartz substrate or a glass panel, and is formed with a plurality of the recesses 211 on a lens-formed area 210a on the surface thereof. Microlenses are formed on the microlens substrate 210 in each recess 211 by an adhesive layer 230 being filled in the recesses 211 for bonding the microlens substrate 210 and a TFT array substrate 10 to each other as described later. In FIG. 1B, the recesses 211 are formed on the microlens substrate 210 in an array pattern, and the inner surfaces thereof define lens surfaces 500 of the microlenses.

In FIG. 2, the lens surfaces 500 defined respectively by the recesses 211 adjacent to each other may be in contact with each other, or may intersect with each other. The lens surfaces 500 defined respectively by the recesses 211 adjacent to each other may be apart from each other. When the lens surfaces 500 are formed so as to intersect with each other as the former case, the effective areas of the respective microlenses as the lens may be increased. Ideally, by forming the four lens surfaces 500 so as to intersect with reach other at respective corners 501, a converging performance may be provided to every corner of the respective microlenses 500, so that the efficiency for light utilization may be improved to the maximum. The shape of the lens surface 500, that is, the curvature of the lens surface may be set individually and specifically according to the optical characteristics required for the microlenses, and may be set, for example, to the spherical surface and the non-spherical surface.

The microlens substrate 210 is bonded to the TFT array substrate 10 in the electro-optical apparatus such as a liquid crystal device as described above. Therefore, the recesses 211 are arranged corresponding to the pitch of a plurality of pixels which constitute an image display area 10a as a pixel area on the TFT array substrate 10.

### 2: Electro-Optical Apparatus

### 2-1: Entire Configuration of Electro-Optical Apparatus

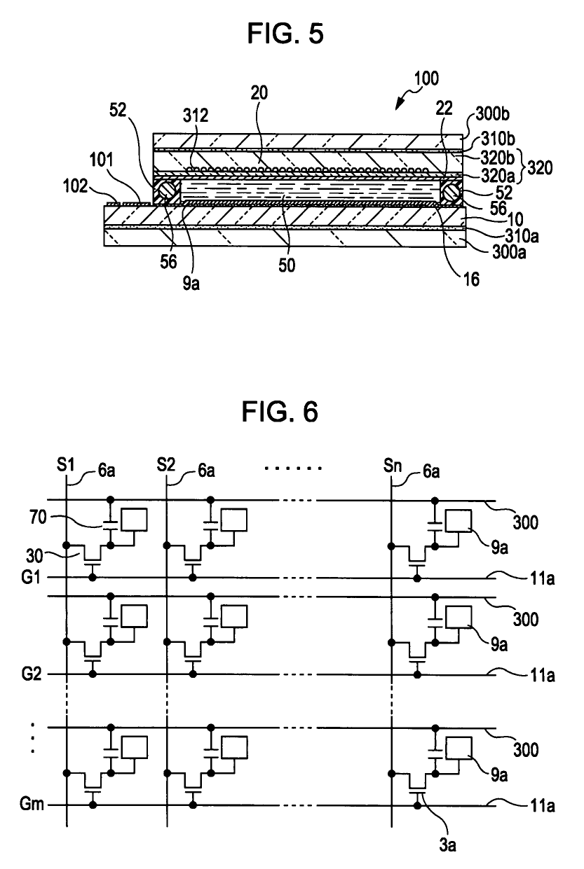

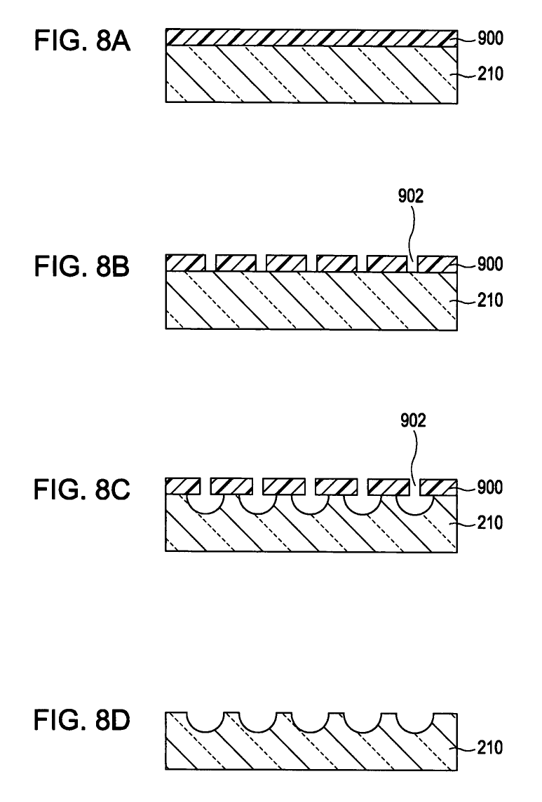

Referring now to FIG. 3 to FIG. 5, the entire configuration of the liquid crystal device as an example of the electro-optical apparatus according to this embodiment. FIG. 3 is a plan view of the liquid crystal device according to this embodiment when viewed from the side of the opposed substrate arranged on the TFT array substrate, and FIG. 4 is a cross-sectional view taken along the line IV-IV in FIG. 3. FIG. 5 is a cross-sectional view showing a configuration of a comparative example of the liquid crystal device according to this embodiment. Here, the liquid crystal device employing a drive-circuit integrated TFT active matrix drive system will be described as an example of the electro-optical apparatus.

In FIG. 3 and FIG. 4, a liquid crystal device 1 includes the TFT array substrate 10, an opposed substrate 20, the microlens substrate 210, and the adhesive layer 230. The TFT array substrate 10 is an example of a first substrate. The opposed substrate 20 is an example of a second substrate. Filled between the TFT array substrate 10 and the opposed substrate 20 is a liquid crystal layer 50. The liquid crystal layer 50 is an example of an electro-optical substance. The TFT array substrate 10 and the opposed substrate 20 are bonded to each other by a sealing material 52 provided on a sealed area positioned in the periphery of the image display area 10a as the pixel area in which the plurality of pixels are arranged.

The sealing material 52 is formed of, for example, UV-cured resin or heat-cured resin for bonding the both substrates, which is applied onto the TFT array substrate 10 and cured by being irradiated with UV rays or applied with heat in a manufacturing process. The sealing material 52 includes gap material 56 such as glass fibers or glass beads for adjusting the distance (inter-substrate gap) between the TFT array substrate 10 and the opposed substrate 20 dispersed therein to a predetermined value. That is, the electro-optical apparatus in this embodiment is compact as a light valve for a projector and hence is suitable for an enlarged display.

A frame light-shielding film 53 having a light-shielding property for defining a frame area of the image display area 10a is provided on the side of the opposed substrate 20 in parallel to the inside of the sealed area having the sealing material 52. However, a part or the entire part of the frame light-shielding film 53 may be formed as the integrated light-shielding film on the surface of the opposed substrate 20 on the side of the TFT array substrate 10.

In an area positioned on the outside of the sealed area of the peripheral area arranged on the periphery of the image display area 10a and provided with the sealing material 52 arranged thereon, a data line drive circuit 101 and external circuit connecting terminals 102 are provided along one side of the TFT array substrate 10. A scanning line drive circuit 104 is provided along either one of two sides adjacent to this side so as to be covered by the frame light-shielding film 53. It is also possible to provide the scanning line drive circuits 104 along two sides adjacent to the one side of the TFT array substrate 10 along which the data line drive circuit 101 and the external circuit connecting terminals 102 are provided. In this case, the two scanning line drive circuits 104 are electrically connected to each other by a plurality of wirings provided along remaining one side of the TFT array substrate 10.

Upper and lower conductive materials 106 which function as upper and lower conductive terminals between the both substrates are arranged at four corners of the opposed substrate 20. On the other hand, the TFT array substrate 10 is provided with upper and lower conductive terminals in areas opposing the corners. Electrical conduction between the TFT array substrate 10 and the opposed substrate 20 is achieved by these upper and lower conductive terminals.

In FIG. 4, formed on the TFT array substrate 10 is an alignment film 16 on pixel electrodes 9a having formed with wirings such as TFTs as pixel switching elements, scanning lines, and data lines. The opposed substrate 20 is formed with an opposed electrode opposing the pixel electrodes 9a on a surface exposed to the TFT array substrate 10, and an alignment film 22 is formed so as to cover the opposed electrode. The alignment films 16 and 22 are formed of organic material such as polyimide or inorganic films formed by depositing inorganic material through rhomble deposition. The liquid crystal layer 50 is formed of liquid crystal in which one or a plurality of types of nematic liquid crystal, and a predetermined alignment state is assumed between a pair of the alignment films.

The microlens substrate 210 is arranged on the opposite side of the opposed substrate 20 with reference to the TFT array substrate 10. The adhesive layer 230 is filled in the lens surfaces 500 of the recesses 211, and bonds the microlens substrate 210 and the TFT array substrate 10 with respect to each other.

The adhesive layer 230 is formed of transparent adhesive agent cured after bonding the microlens substrate 210 and the TFT array substrate 10 with respect to each other in a state of being applied on the surface of the TFT array substrate 10 exposed to the microlens substrate 210, or on the surface of the microlens substrate 210 formed with the recesses 211. In this case, microlenses 212 are formed of the adhesive agent which constitutes the adhesive layer 230 filled in the recesses 211.

Light sources, not shown, which supply light beams to the liquid crystal device 1 when the liquid crystal device 1 is in operation are arranged on the side of the microlens substrate 210 when viewed from the TFT array substrate 10. The light beams emitted from the light sources enter the microlens substrate 210 from the lower side of the microlens substrate 210 in the drawing. The microlenses 212 converge incident light beams entering the microlens substrate 210 to apertures of the respective pixels on the TFT array substrate 10, so that a desired image is displayed on the image display area 10a according to the state of alignment of the liquid crystal layer 50.

Here, referring to FIG. 5, a configuration of the liquid crystal device in the related art as a comparative example of the liquid crystal device 1 according to this embodiment will be described. Components of a liquid crystal device 100 in the comparative example which are common to the liquid crystal device 1 are designated by common reference numerals.

In FIG. 5, the liquid crystal device 100 mainly includes a dustproof glass substrate 300a, adhesive agent layers 310a and 310b, the TFT array substrate 10, a microlens substrate 320, a dustproof glass substrate 300b, and the liquid crystal layer 50. The microlens substrate 320 includes a plurality of microlenses 312 formed by filling the adhesive agent for bonding a substrate body 320b and a cover glass substrate 320a with respect to each other in recesses formed on the surface of the substrate body 320b. The dustproof glass substrate 300a and the TFT array substrate 10 are bonded to each other via the adhesive layer 310a formed of a heat-cured material or a UV-cured material. The dustproof glass substrate 300b and the microlens substrate 320 are bonded to each other via the adhesive layer 310b formed of the heat-cured material or the UV-cured material.

In a manufacturing process of the liquid crystal device 100, in order to bond the dustproof glass substrates 300a and 300b to the TFT array substrate 10 and the microlens substrate 320 respectively, a step of heating the adhesive layers 310a and 310b respectively, or a step of making the adhesive layers 310a and 310b to be irradiated with the UV-rays respectively is required. In addition, a step of bonding the cover glass substrate 320a and the substrate body 320b with adhesive agent or the like is required when forming the microlens substrate 320. In this case, when the adhesive agent is formed of the heat-cured material or the UV-cured material, a heating step or a UV-ray exposure step is required.

On the other hand, as shown in FIG. 4, according to the configuration of the liquid crystal device 1, since the dustproof glass is not included, the heating step or the UV-ray exposure step for bonding the dustproof glass to the TFT array substrate 10 or the like may be eliminated, the heating step or the UV-ray exposure step for curing the adhesive layer may be reduced in comparison with the case of manufacturing the liquid crystal device 100. In addition, a step of bonding the microlens substrate 210 and the TFT array substrate 10 via the adhesive layer 230 may also serve as the heating step for curing the adhesive agent filled in the recesses 211 or the UV-ray exposure step.

Therefore, according to the configuration of the liquid crystal device 1, the step of bonding the respective components of the liquid crystal device 100 to each other via the adhesive agent may be reduced. Accordingly, the energy consumption in the heating step or the UV-ray exposure step for curing the adhesive layer may be reduced thereby reducing the load to the environment which may increase with increase in energy consumption. In particular, when the liquid crystal devices 1 are manufactured in a large scale in the large-scale production process, the energy consumption in the heating step or the like may be remarkably reduced with the effect of the large-scale production in comparison with the case of manufacturing a small quantity of the liquid crystal devices.

In addition, as shown in FIG. 4 and FIG. 5, the three substrates; the TFT array substrate 10, the opposed substrate 20 and the microlens substrate 210 are included in the main components of the liquid crystal device 1, and the five substrates; the two dustproof glass substrates 300a and 300b, the TFT array substrate 10, the cover glass substrate 320a, and the substrate body 320b are included in the main components of the liquid crystal device 100. Therefore, according to the liquid crystal device 1, the members which constitute the liquid crystal device 1 may be reduced in comparison with the members which constitute the liquid crystal device 100, and the resources may be utilized effectively.

In addition to the data line drive circuit 101 and the scanning line drive circuit 104, it is also possible to form circuits such as a sampling circuit for sampling image signals on the image signal lines and supplying the signal to the data lines, a precharge circuit for supplying precharge signals of a predetermined voltage level to a plurality of data lines prior to the image signals, and an inspection circuit for inspecting the quality or defects of the electro-optical apparatus during manufacture or at the time of shipping on the TFT array substrate 10 shown in FIG. 3 and FIG. 4.

### 2-2: Circuit Configuration of Electro-Optical Apparatus

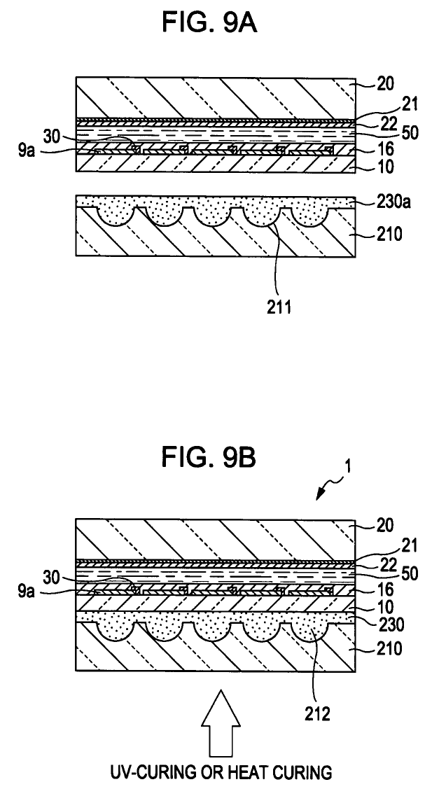

Referring now to FIG. 6, a circuit configuration and an operation of the electro-optical apparatus configured as described above will be described. FIG. 6 is a circuit diagram showing an equivalent circuit including various elements and wirings in a plurality of pixels formed in a matrix pattern, which constitutes an image display area of the electro-optical apparatus.

In FIG. 6, the plurality of pixels formed in a matrix pattern which configures the image display area 10a of the liquid crystal device 1 each include a pixel electrode 9a and a TFT 30 for switching the pixel electrode 9a, and a data line 6a to which the image signals are supplied is electrically connected to a source of the TFT 30. The TFT 30 is an example of an “electronic element” of the electro-optical apparatus according to the invention. Image signals S1, S2, . . . , Sn to be written in the data lines 6a may be supplied in this order in line sequence and may be supplied to a group of the plurality of adjacent data lines 6a in group basis.

Gate electrodes 3a are electrically connected to gates of the TFT 30, and are configured to apply scanning signals G1, G2, . . . , Gm to scanning lines 11a and the gate electrodes 3a in pulses at predetermined timings in this order in line sequence. The pixel electrodes 9a are electrically connected to the drains of the TFTs 30, and write the image signals S1, S2, . . . , Sn supplied from the data lines 6a at a predetermined timing by closing the TFTs 30 as the switching elements for a certain period.

The image signals S1, S2, . . . , Sn of a predetermined level written in the liquid crystal as an example of the electro-optical substance via the pixel electrodes 9a are held for a predetermined period with respect to the opposed electrode formed on the opposed substrate 20. The liquid crystal modulates the light beams by the change of alignment or order of the molecular association according to the applied voltage level, so that the gradation display is enabled. In the case of the normally white mode, the coefficient of transmission (coefficient of reflection in a case in which the pixel electrode is the reflective type) for incident light beams is reduced according to the voltages applied on the pixel basis. In the case of the normally black mode, the coefficient of transmission for the incident light beams is increased according to the voltage applied on the pixel basis, and light beams having a contrast according to the image signals are outputted from the liquid crystal device 1 as a whole.

In order to prevent the image signals held here from leaking, storage capacitors 70 are added in parallel to liquid crystal capacitors formed between the pixel electrodes 9a and the opposed electrode. The storage capacitors 70 are provided in parallel with the scanning lines 11a, and include capacity electrodes 300 each including a fixed potential side capacity electrode and being fixed to a constant potential.

### 2-3: Detailed Configuration of Electro-Optical Apparatus

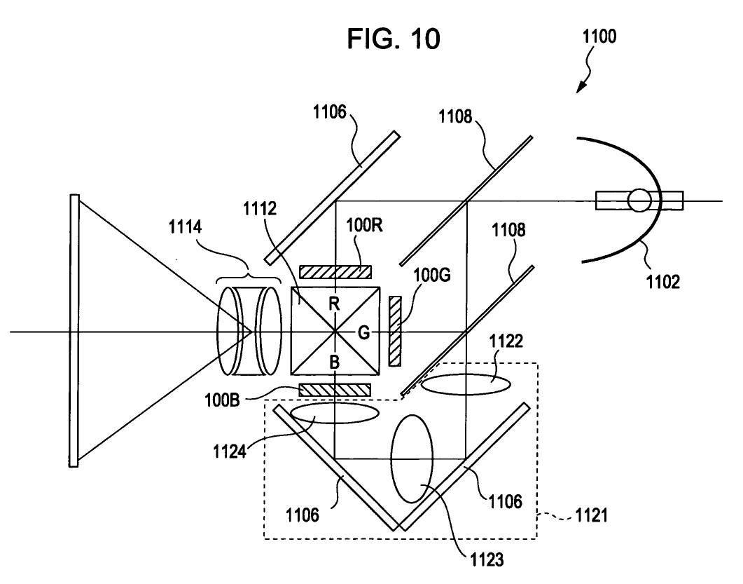

Referring now to FIG. 7, a detailed configuration of a principal portion of the liquid crystal device 1 will be described. FIG. 7 is a cross-sectional view showing a principal portion of the cross-section of the pixel portion of the liquid crystal device 1 taken along the cross-section corresponding to FIG. 4 in an enlarged scale.

In FIG. 7, the microlenses 212 are formed on the microlens substrate 210 at the same pitch as the pixels on the TFT array substrate 10. The microlens substrate 210 is bonded to the TFT array substrate 10 via the adhesive layer 230 in a state of being positioned so that the microlenses 212 correspond to the pixel electrodes 9a. The microlenses 212 converge incident light beams entering from the back side of the microlens substrate 210 into the microlens substrate 210 to the pixel electrodes 9a. The areas on the TFT array substrate 10 on which the TFTs 30 are arranged correspond to non-opening areas which are not irradiated with light beams converged by the microlenses 212, and the light beams are outputted to the outside of the apparatus via the apertures including the areas on which the pixel electrodes 9a are formed. Therefore, the TFTs 30 arranged between the adjacent pixel electrodes 9a are not irradiated with the light beams converged by the microlenses 212.

On the other hand, according to the liquid crystal device 100 shown in FIG. 5, the light sources are arranged on the side where the dustproof glass substrate 300b is arranged when viewed from the upper side in the drawing, that is, from the microlens substrate 320, and the TFT array substrate 10 is irradiated with the light beams emitted from the light sources from the side of the microlens substrate 320 when viewed from the TFT array substrate 10. Therefore, in order to prevent the TFTs formed on the TFT array substrate 10 from being irradiated with the light beams, it is necessary to provide a light-shielding film for defining the non-opening areas which partition the apertures of the respective pixels from each other on the microlens substrate 320.

However, according to the liquid crystal device 1, since the incident light beams enter through the back side of the TFT array substrate 10, on which the TFTs 30 are not formed, from between the both surfaces of the TFT array substrate 10, the TFTs 30 are shielded from light by the wirings or the like having the light-shielding property formed on inside the TFT array substrate 10 or the underlayer side of the TFTs 30, so that a light leak current generated on the TFTs 30 may be reduced. In addition, since the incident light beams are converged into the apertures by the microlenses 212 so that the TFTs 30 are not irradiated with the light beams, the light leak current generated on the TFTs 30 may be reduced further effectively. According to the liquid crystal device 1, the light beams with which the TFTs 30 are irradiated may be reduced sufficiently without forming the light-shielding film that defines the non-opening areas on the microlens substrate 320 as in the case of the liquid crystal device 100.

Therefore, according to the configuration of the liquid crystal device 1, the number of steps included in the manufacturing process for manufacturing the liquid crystal device 1 may be reduced to the number smaller than the number of steps in the manufacturing process for manufacturing the liquid crystal device 100. Accordingly, the manufacturing cost required for manufacturing the liquid crystal device 1 may be reduced and, in addition, the energy to be consumed in the manufacturing process may also be reduced.

In FIG. 7, since the thickness t1 of the TFT array substrate 10 is smaller than the thickness t2 of the opposed substrate 20 and the thickness t3 of the microlens substrate 210, it is advantageously possible to display the high quality images by the desirable defocusing characteristic. In addition, there is also an advantage that the electronic elements such as the TFTs 30 or the various wirings may be formed easily on the TFT array substrate 10 by reducing the thickness t1 of the TFT array substrate 10.

The thickness t1 of the TFT array substrate 10 may be set independently and in detail according to the pixel pitch, the relative relation with respect to the thicknesses t2 and t3 of the opposed substrate 20 and the microlens substrate 210, and the optical characteristics such as the refractive index of the respective substrates and the adhesive layer 230.

In this manner, according to the electro-optical apparatus in this embodiment, the various members which constitute the electro-optical apparatus may be reduced with respect to the electro-optical apparatus in the related art without lowering the display performance as well as the energy consumption during the manufacturing process. Therefore, according to the electro-optical apparatus in this embodiment, the electro-optical apparatus in which the load applied to the environment is reduced may be provided, and the effective utilization of resources is achieved.

According to the electro-optical apparatus in this embodiment described thus far, a polarizing film, a retardation film, and a polarizing panel may be arranged in predetermined directions on the light-exit side of the opposed substrate 20 and the light-entrance side of the microlens substrate 210 respectively depending on the operation mode such as TN (Twisted Nematic) mode, VA (Vertically Aligned) mode, PDLC (Polymer Dispersed Liquid Crystal) mode or depending whether it is the normally white mode or the normally black mode.

### 3: Method of Manufacturing Electro-Optical Apparatus

Referring now to FIGS. 8A to 8D and FIGS. 9A to 9B, a method of manufacturing the electro-optical apparatus according to this embodiment will be described. FIGS. 8A to 8B and FIGS. 9A to 9B are process cross-sectional views schematically showing an example of a manufacturing process of the above-described liquid crystal device 1.

As shown in FIG. 8A, an amorphous silicon film is formed through, for example, CVD (Chemical Vapor Deposition) or the like as a mask 900 on the microlens substrate 210 on which the recesses 211 are not formed. The mask 900 may be a Cr film or a polysilicon film having a hydrofluoric-acid-resistant property.

Subsequently, as shown in FIG. 8B, a plurality of openings 902 are formed at positions on the mask 900 corresponding to the positions where the recesses 211 are formed shown in FIG. 1 or FIG. 2B, for example, through a patterning using photolithography with respect to the mask 900. In the mask 900, the plurality of openings 902 are each formed into a circular shape in plan view having a size smaller than the recess 211 formed on the microlens substrate 210 corresponding to the openings 902.

Subsequently, in FIG. 8C, the plurality of recesses 211 are formed by applying isotropy etching on the microlens substrate 210 via the mask 900 on which the plurality of openings 902 are formed. More specifically, the isotropy etching is performed through wet etching using etchant of, for example, a hydrofluoric acid system.

Subsequently, as shown in FIG. 8D, the mask 900 is removed through the etching process, and the microlens substrate 210 having the plurality of recesses 211 which define the lens surfaces formed thereon.

Subsequently, as shown in FIG. 9A, the adhesive agent is applied on the surface of the microlens substrate 210 on which the recesses 211 are formed, so that uncured adhesive layer 230 is formed in the recesses 211. Simultaneously, or about that time, a structure including the TFT array substrate 10 and the opposed substrate 20 bonded to each other with the liquid crystal layer 50 sandwiched therebetween is formed.

Subsequently, in FIG. 9B, the structure including the TFT array substrate 10 and the opposed substrate 20 is bonded to the microlens substrate 210 via the adhesive layer 230a. Subsequently, the adhesive layer 230a is cured by the UV irradiation or the heating process to form the adhesive layer 230, so that the TFT array substrate 10 and the microlens substrate 210 are bonded to each other, whereby the microlenses 212 are formed and the liquid crystal device 1 is formed.

According to a method of manufacturing the electro-optical apparatus in this embodiment, the energy consumption during the manufacturing process is reduced, and the load applied to the environment is reduced as the electro-optical apparatus according to this embodiment described above.

### 4: Electronic Equipment

Referring now to FIG. 10, an embodiment of electronic equipment having the electro-optical apparatus according to this embodiment will be described. In the following description, a projective color display device using the aforementioned liquid crystal device 1 as a light valve as an example of the electronic equipment in this embodiment will be described. The entire configuration, in particular, the optical configuration thereof will be descried below. FIG. 10 is a schematic cross-sectional view of the projective color display device.

As shown in FIG. 10, a liquid crystal projector 1100 as an example of the projective color display device includes three liquid crystal modules including the liquid crystal device having a drive circuit mounted on the TFT array substrate, which are used as light valves 100R, 100G and 100B for RGB colors, respectively. In the liquid crystal projector 1100, when a projecting light is emitted from a lamp unit 1102 as a white light source such as a metal halide lamp or the like, the light is divided into light components R, G and B which correspond to the RGB primary colors by three mirrors 1106 and two dichroic mirrors 1108, and each components are guided to the light valves 100R, 100G and 100B corresponding to the respective colors. In this case, in particular, light B is guided via a relay lens system 1121 including an entrance lens 1122, a relay lens 1123 and an exit lens 1124 in order to prevent light loss due to a long optical path. The light components corresponding to the three primary colors modulated respectively by the light valves 100R, 100G and 100B are combined again by a dichroic prism 1112, and are projected via a projection lens 1114 onto a screen as a color image.

According to the electronic equipment in this embodiment of the invention, various types of electronic equipment such as projective display devices, TVs, mobile phones, electronic data books, word processors, view-finder type or monitor-direct-view video tape recorders, work stations, TV phones, POS terminals, touch panels, and so on in addition to the electronic equipment described in conjunction with FIG. 10 which achieves high-quality display are realized. It is also possible to realize, for example, an electrophoresis apparatus such as electronic paper, an electron emission apparatus (Field Emission Display and Conduction Electron-Emitter Display), and Digital Light Processing employing the electrophoresis apparatus and the electron emission apparatus as an apparatus employing the electrophoresis apparatus, Field Emission Display and Conduction Electron-Emitter Display as the electronic equipment according to the embodiment of the invention.

The invention is not limited to the embodiments shown above, and may be modified as needed without departing the scope or idea of the invention which is understood from appended claims and the entire specification, and the electro-optical apparatus including such modifications, a method of manufacturing the same, and electronic equipments are also included in the technical field of the invention.

The entire disclosure of Japan Patent Application No. 2006-161988, filed Jun. 12, 2006 is expressly incorporated by reference herein.

What is claimed is:

1. An electro-optical apparatus comprising:
a first substrate;
a plurality of pixels on one surface of the first substrate, each pixels having an aperture;
a microlens substrate arranged on an other surface of the first substrate opposite from the one surface and having lens surfaces of microlenses located at the respective apertures on the surface thereof; and
an adhesive layer filled in the lens surfaces for bonding the microlens substrate and the first substrate to each other.

2. The electro-optical apparatus according to claim 1 comprising: a second substrate which is arranged on the side of the one surface of the first substrate so as to oppose thereto via an electro-optical substance, wherein the thickness of the first substrate may be thinner than the respective thicknesses of the microlens substrate and the second substrate.

3. A method of manufacturing an electro-optical apparatus including: a first substrate; a plurality of pixels on one surface of the first substrate, each pixels having an aperture; a microlens substrate arranged on an other surface of the first substrate opposite from the one surface and having lens surfaces of microlenses located at the respective apertures on the surface thereof; and an adhesive layer filled in the lens surfaces for bonding the microlens substrate and the first substrate to each other, comprising:
forming the adhesive layer; and
bonding the microlens substrate and the first substrate via the adhesive layer.

4. Electronic equipment comprising the electro-optical apparatus according to claim 1.
